(19) United States
(12) Patent Application Publication
(10) Pub. No.: US 2008/0082999 A1
(43) Pub. Date: Apr. 3, 2008

(54) Broadcast receiver, server device and program recommending method of broadcast receiver

(75) Inventors: Tomo Hamada, Akishima-shi (JP); Kazuhiko Muguruma, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/905,055

(22) Filed: Sep. 27, 2007

(30) Foreign Application Priority Data
Sep. 29, 2006 (JP) 2006-269858

(51) Int. Cl. H04N 7/10

(52) U.S. Cl. 725/46

(57) ABSTRACT

According to one embodiment, a broadcast receiver includes a tuner which receives and demodulates a broadcast signal, an extracting section which extracts electronic program information from the demodulated broadcast signal, a generating section which displays a setting screen and generates input information for the setting screen, a communication section which transmits the input information to an external server device and receives watching history data corresponding to the input information from the server device, and a preference learning section which creates a recommended program list based on the watching history data and the electronic program information and generates program recommendation screen information for displaying recommended programs according to the recommended program list.

### CROSS-REFERENCE TO RELATED APPLICATIONS

This application is based upon and claims the benefit of priority from Japanese Patent Application No. 2006-269858, filed Sep. 29, 2006, the entire contents of which are incorporated herein by reference.

### BACKGROUND

1. Field

One embodiment of the invention relates to a broadcast receiver, and particularly to a broadcast receiver which handles users' preference information, a server device and a program recommending method of the broadcast receiver.

2. Description of the Related Art

Recently, digital broadcast receivers are being developed and becoming widely used, and their functions are diversified. Some of such digital broadcast receivers have a function of recommending programs using electronic program information. Further, devices which are provided with the function of recommending programs according to users' preference are known.

Patent Document 1 (Jpn. Pat. Appln. KOKAI Publication No. 2005-332087) discloses the function of recommending programs according to users' preference, and with such a function, programs can be effectively recommended to users from the beginning of a service. A database in which user attribute information is related to program operation history information is stored. As a result, evaluation values of the respective programs in each of segmentalized preference groups are obtained so that the programs are recommended.

In the conventional technique of Patent Document 1, however, the database is stored in advance at the time of purchasing devices. Thus, when the time passes, the database cannot cope with latest programs.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram illustrating one example of a constitution of a broadcast receiver according to one embodiment of the present invention;

FIG. 2 is an explanatory diagram illustrating an exemplary operation of a preference learning function in the broadcast receiver according to one embodiment of the present invention;

FIG. 3 is an explanatory diagram illustrating an exemplary operation of the preference learning function in the broadcast receiver according to one embodiment of the present invention;

FIG. 4 is a flowchart illustrating an exemplary initial setting process of the preference learning function in the broadcast receiver according to one embodiment of the present invention;

FIG. 5 is a flowchart illustrating an exemplary watching history data creating process in a server device for the preference learning function of the broadcast receiver according to one embodiment of the present invention;

FIG. 6 is a flowchart illustrating an exemplary recommended program list creating process using the watching history data in the broadcast receiver according to one embodiment of the present invention;

FIG. 7 is a flowchart illustrating an exemplary program recommendation display process using the recommended program list in the broadcast receiver according to one embodiment of the present invention;

FIG. 8 is an explanatory diagram illustrating one example of an initial setting screen in the broadcast receiver according to one embodiment of the present invention;

FIG. 9 is an explanatory diagram illustrating one example of the initial setting screen in the broadcast receiver according to one embodiment of the present invention;

FIG. 10 is an explanatory diagram illustrating one example of the initial setting screen in the broadcast receiver according to one embodiment of the present invention;

FIG. 11 is an explanatory diagram illustrating one example of the watching history data in the broadcast receiver according to one embodiment of the present invention;

FIG. 12 is an explanatory diagram illustrating one example of the recommended program list in the broadcast receiver according to one embodiment of the present invention; and

FIG. 13 is an explanatory diagram illustrating one example of a recommendation screen in the broadcast receiver according to one embodiment of the present invention.

### DETAILED DESCRIPTION

Various embodiments according to the invention will be described hereinafter with reference to the accompanying drawings. In general, according to one embodiment of the invention, a broadcast receiver comprising: a tuner which receives and demodulates a broadcast signal; an extracting section which extracts electronic program information from the demodulated broadcast signal; a generating section which displays a setting screen and generates input information for the setting screen; a communication section which transmits the input information to an external server device and receives watching history data corresponding to the input information from the server device; and a preference learning section which creates a recommended program list based on the watching history data and the electronic program information and generates program recommendation screen information for displaying recommended programs according to the recommended program list.

One embodiment of the present invention provides a broadcast receiver which is capable of recommending programs according to users' preferences based on a plurality of latest watching history data even just after purchasing products, a server device, and a program recommending method of the broadcast receiver.

One embodiment for achieving the above object is a broadcast receiver including:

a tuner (13) which receives and demodulates a broadcast signal;

an extracting section (43) which extracts electronic program information from the demodulated broadcast signal;

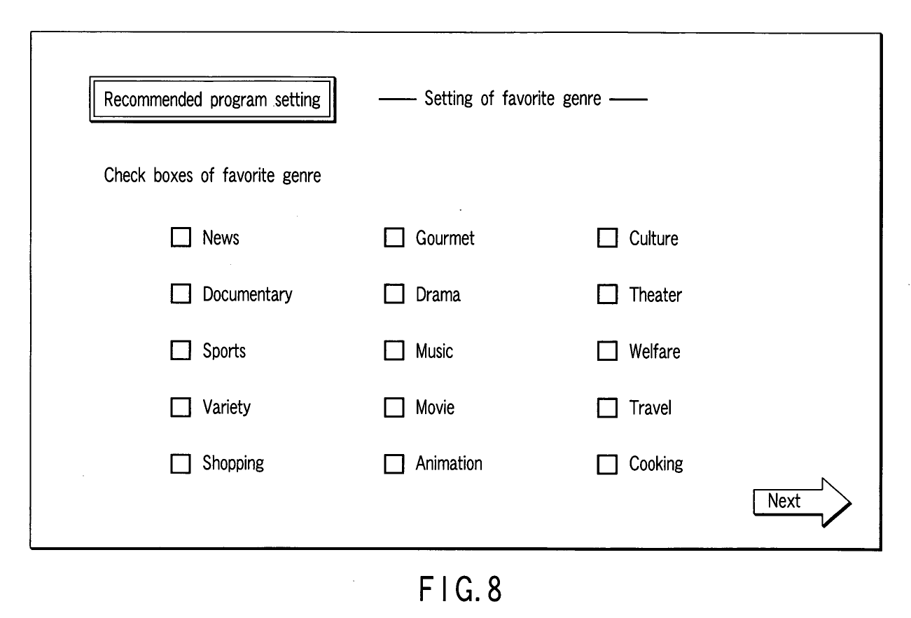

a generating section (34) which displays a setting screen (FIGS. 8, 9, and 10) and generates input information for the setting screen;

a communication section (11) which transmits the input information to an external server device (S) and receives watching history data (FIG. 11) corresponding to the input information from the server device; and

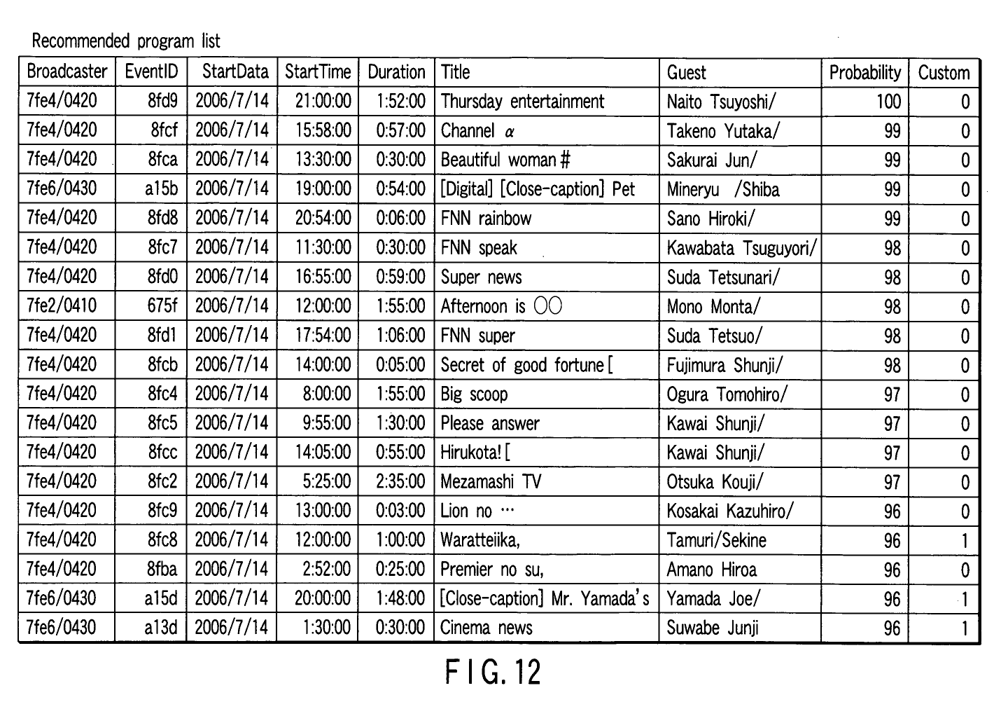

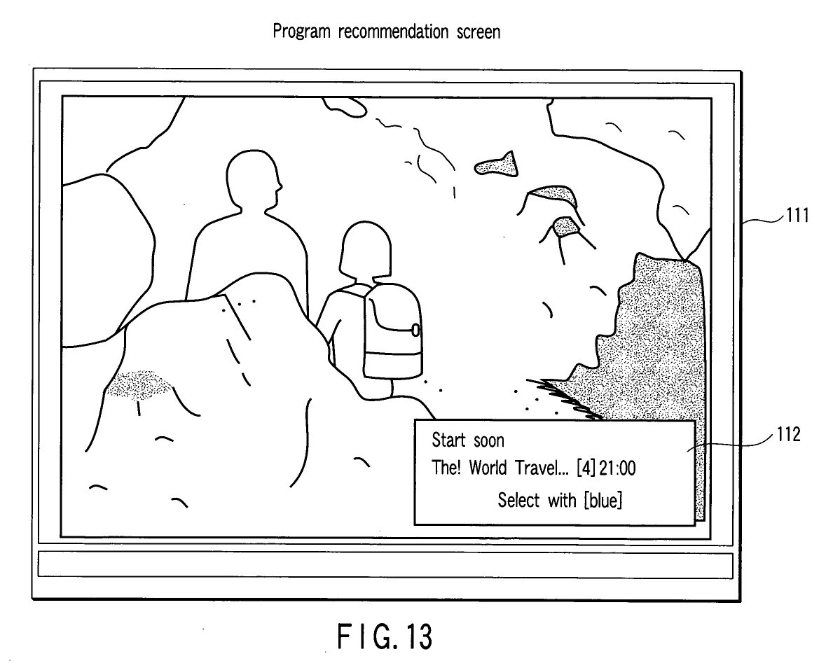

a preference learning section (34) which creates a recommended program list (FIG. 12) based on the watching history data and the electronic program information and generates program recommendation screen information (FIG. 13) for displaying recommended programs according to the recommended program list.

As a result, in the broadcast receiver, information is input into a user's preference setting screen so that a recommended program list is created based on the input information and a plurality of users' watching history data on a server, and thus suitable programs can be recommended even just after purchasing the broadcast receiver.

An embodiment of the present invention will be described in detail below with reference to the drawings.

<The Broadcast Recording Device according to One Embodiment of the Present Invention>

(Constitution)

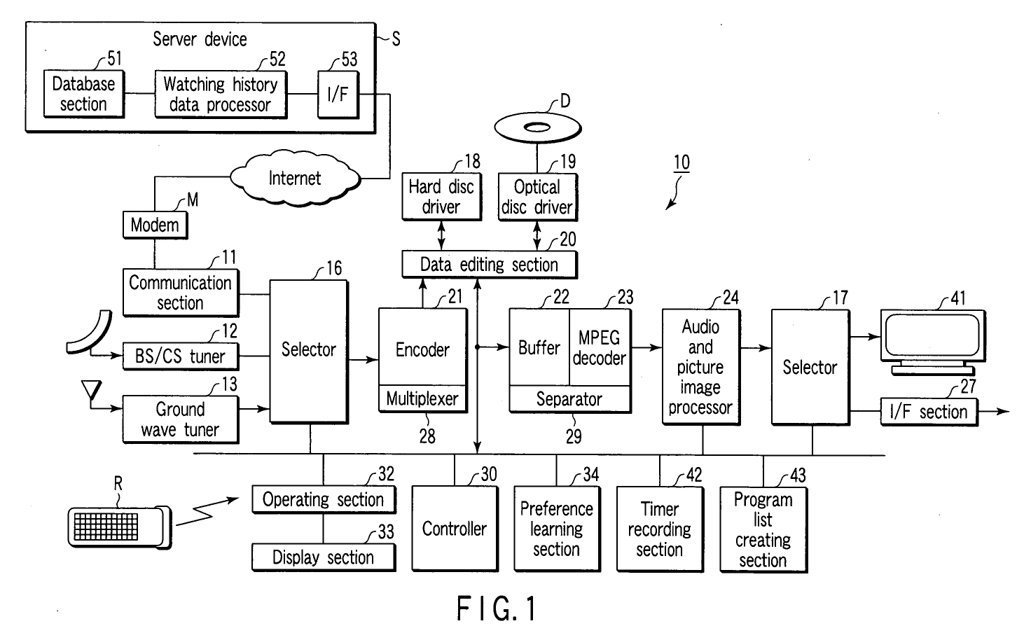

FIG. 1 is a block diagram illustrating an exemplary constitution of a broadcast recording device according to one embodiment of the present invention. An optical disc recording/reproducing device having a hard disc recorder function will be described as the broadcast receiver according to one embodiment of the present invention. The broadcast receiver, however, includes various forms and all these forms fall within a range of the embodiment of the present invention.

A broadcast recording device 10 in FIG. 1 has two kinds of disc drivers. The broadcast recording device 10 has an optical disc driver 19 which drives to rotate an optical disc D which is a first medium serving as an information recording medium in which a video file can be structured and executes reading and writing of information. The broadcast recording device 10 also has a hard disc driver 18 which drives a hard disc as a second medium. A controller 30 is connected to the respective sections via a data bus in order to control an entire operation.

The broadcast recording device 10 in FIG. 1 mainly includes an encoder 21 which constitutes a recording side, an MPEG decoder 23 which constitutes a reproducing side, and the controller 30 which controls an operation of the device main body. The broadcast recording device 10 has a selector 16 on an input side and a selector 17 on an output side. The selector 16 on the input side is connected to a communication section 11 such as LAN, a so-called satellite broadcast (BS/CS) tuner 12 and a so-called ground wave tuner 13, so as to output a signal to the encoder 21. The BS/CS tuner 12 is connected to a satellite antenna, and the ground wave tuner 13 is connected to a ground wave antenna. The broadcast recording device 10 has the encoder 21, a data editing section 20 which receives an output from the encoder 21 and executes a desired data process such as data editing, the hard disc driver 18 which is connected to the data editing section 20, and the optical disc driver 19. The broadcast recording device 10 has the MPEG decoder 23 which receives signals from the hard disc driver 18 and the optical disc driver 19 and decodes the signals, the encoder 21, a buffer 22, a multiplexer 28, a separator 29, the controller 30, a preference learning section 34, a timer recording section 42, and a program list creating section 43 which extracts electronic program information from a demodulated signal of a broadcast signal and creates a reservation list and a program list image. These sections are connected to the controller 30 via a data bus. An output from the selector 17 is supplied to an external device via an interface section 27 which is connected to an external image receiver 41 or communicates with the external device.

The broadcast recording device 10 further has an operating section 32 which is connected to the controller 30 via the data bus and receives a user's operation and operation of a remote controller R. The remote controller R enables an operation approximately equivalent to that of the operating section 32 provided to a main body of the broadcast recording device 10. The remote controller R enables recording and reproducing commands in the hard disc driver 18 and the optical disc driver 19, an editing command, an operation of the tuner, and various settings such as setting of timer recording.

(Operation)

Basic Operation

Summaries of the reproducing process and the recording process from/into an optical disc as an example in the broadcast recording device 10 having such a constitution will be described. Under the control of the controller 30, the optical disc D which is rotated at a predetermined speed is irradiated with a laser beam and its reflected light is detected by an optical pickup, and a detected signal based on the reflected light is output. An RF signal is generated based on the detected signal, and a data reading process and then a reproducing process are executed.

In the optical disc recording process under the control of the controller 30, data supplied via an input section, not shown, and the selector 16 are supplied to the encoder 21 so as to be encoded and output. A driving current of a laser driver is supplied to the optical pickup according to the encoded output and an output from the controller 30, and is emitted to a storage region of the optical disc D so that the recording process is executed.

Recording Process

The operation of the broadcast recording device 10 having such a constitution will be described in detail below. First, the operation at the time of recording including the other modes will be mainly described in detail. On the input side of the broadcast recording device 10, the communication section 11 such as LAN is connected to an external device and communicates with a program information providing server device S by way of a communication path such as an internet via a modem M, or downloads contents information. The BS/CS tuner 12 and the ground wave tuner 13 select and demodulate broadcast signals via antennas so as to input video signals and audio signals, and cope with various kinds of broadcast signals. Examples include, but not limited to, ground wave analog broadcast, ground wave digital broadcast, BS analog broadcast, BS digital broadcast and CS digital broadcast. The present invention includes a case where the broadcast recording device 10 has not necessarily one tuner but may have two or three or more ground wave analog broadcast tuners and BS/CS tuners so as to execute the recording processes in parallel according to requests of timer recording.

The device of FIG. 1 can supply information encoded by the encoder 21 (a package including video, audio and sub-video data) and created management information via the controller 30 to the hard disc driver 18 or the optical disc driver 19. The device can then record the information in the hard disc driver 18 or the optical disc D. The information recorded in the hard disc driver 18 or the optical disc D can be recorded into the optical disc D or the hard disc driver 18 via the controller 30 and the optical disc driver 19.

Reproducing Process

The reproducing process for recorded information including the other modes will be mainly described in detail below. The MPEG decoder 23 includes a video processor which suitably synthesizes a decoded sub-video picture with a decoded main video picture and outputs a picture in which a menu, a highlight button, subtitles and the other sub-video pictures are superposed on the main video picture.

An output audio signal from the MPEG decoder 23 is converted into an analog signal by an digital-analog converter, not shown, via the selector 17 so as to be supplied to a speaker or to an external device via the I/F section 27. The selector 17 is controlled by a select signal from the controller 30. As a result, when the selector 17 directly monitors digital signals from the respective tuners 12 and 13, it can directly select the signal which has passed through the encoder 21.

Timer Recording Process

The timer recording process is enabled based on electronic program information acquired from the communication section 11 according to programs specified by user's operation of the remote controller R. When the time set by the timer comes, the video/audio signals obtained by demodulating program information received by the BS/CS tuner 12 or the ground wave tuner 13 are subject to the encoding process of the encoder 21 so as to be recorded (timer-recorded) into the hard disc drive 18, for example, by the operations of the controller 30 and the timer recording section 42 based on the timer recording information.

The broadcast recording device 10 in this embodiment has such a comprehensive function, and records/reproduces a lot of sources into/from the optical disc D or the hard disc driver 18.

(Constitution of the Server Device)

The server device S is composed of a database section 51, a watching history data processor 52, and an I/F section 53 as shown in FIG. 1 as an example. The database section 51 stores therein watching history data supplied from a plurality of users using a lot of broadcast receivers 10. The watching history data processor 52 outputs a plurality of suitable watching history data from the plurality of watching history data of the users based on the input information from the broadcast receiver 10. The I/F section 53 communicates with an external device.

<Program Recommending Process Using Electronic Program Information and the Server Device>

The program recommending process in the broadcast receiver using electronic program information and the server device will be described in detail below with reference to flowcharts.

(Outline)

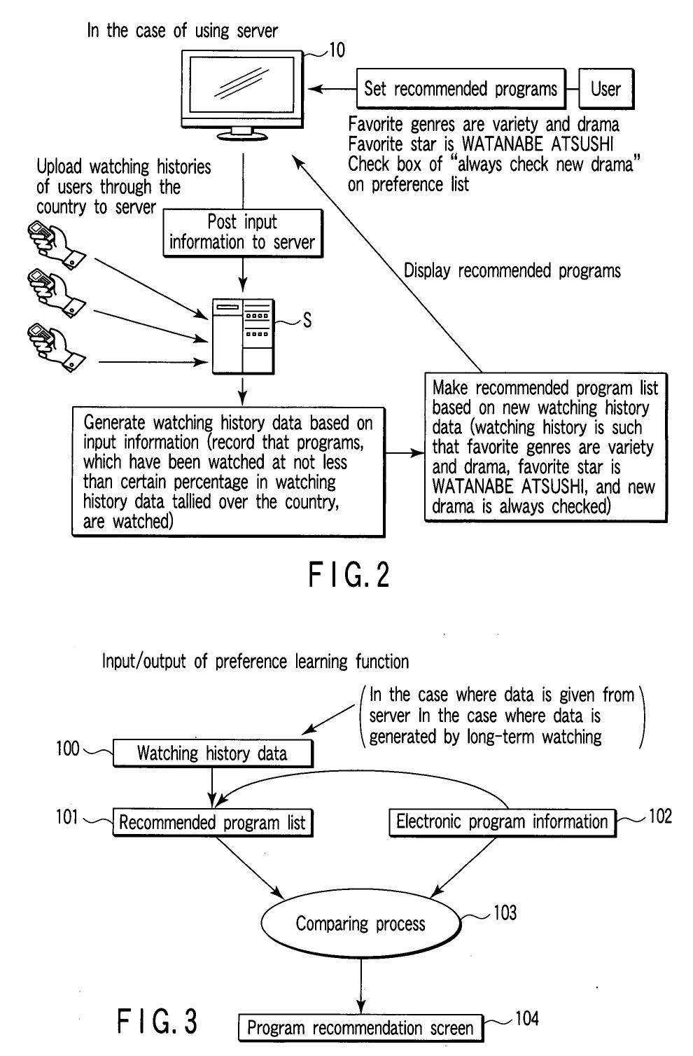

The outline of the program recommending process using the electronic program information and the server device to be executed by the broadcast receiver according to one embodiment of the present invention will be described with reference to the drawings. FIG. 2 is an explanatory diagram illustrating an exemplary operation of a preference learning function in the broadcast receiver according to one embodiment of the present invention. FIG. 3 is an explanatory diagram illustrating an exemplary operation of the preference learning function.

FIGS. 8 to 10 are explanatory diagrams illustrating one example of an initial setting screen in the broadcast receiver according to one embodiment of the present invention. FIG. 11 is an explanatory diagram illustrating one example of the watching history data, FIG. 12 is an explanatory diagram illustrating one example of a recommended program list, and FIG. 13 is an explanatory diagram illustrating one example of a recommendation screen.

That is to say, the program recommending process using the electronic program information and the server device according to one embodiment of the present invention enables the program recommending process according to users' preferences even just after purchasing the broadcast receivers. That is to say, as shown in FIGS. 2 and 3, information is input into a user's recommended program setting (program preference setting) screen (FIGS. 8 to 10), and the input information is transmitted to the server device S. The server device S synthesizes a plurality of watching history data detected by the server device S so as to transmit the synthesized data to the broadcast receiver 10 of a client.

The broadcast receiver 10 compares a recommended program list (FIG. 12) 101 according to the transmitted watching history data (FIG. 11) 100 with the electronic program information so as to create the list. A comparing process 103 is executed on periodic electronic program information and the recommended program list (FIG. 12), so that a program recommendation screen (FIG. 13) 104 showing programs to be recommended is displayed on a screen.

As a result, the program recommending process can be executed according to the user's preference even at a stage in which user's watching history data is not present just after purchasing the broadcast receiver 10.

(Initial Setting Process)

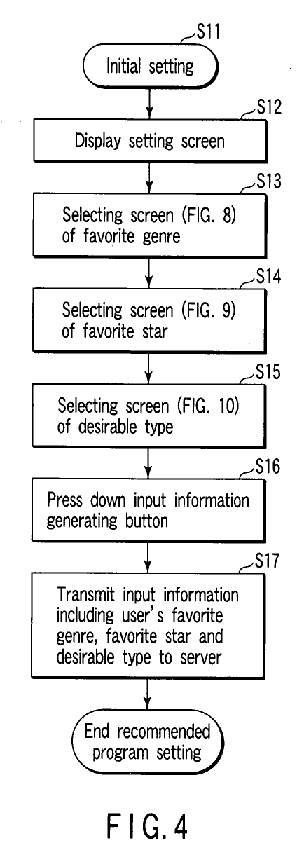

An initial setting process which is executed by inputting information into the user's recommended program setting screen (FIGS. 8 to 10) just after purchasing the broadcast receiver will be described in detail below with reference to the drawings. FIG. 4 is a flowchart illustrating the exemplary initial setting process of the preference learning function.

Each step of the flowcharts in FIGS. 4 to 7 can be replaced by each circuit block, and therefore all the steps in the flowcharts can be redefined as blocks.

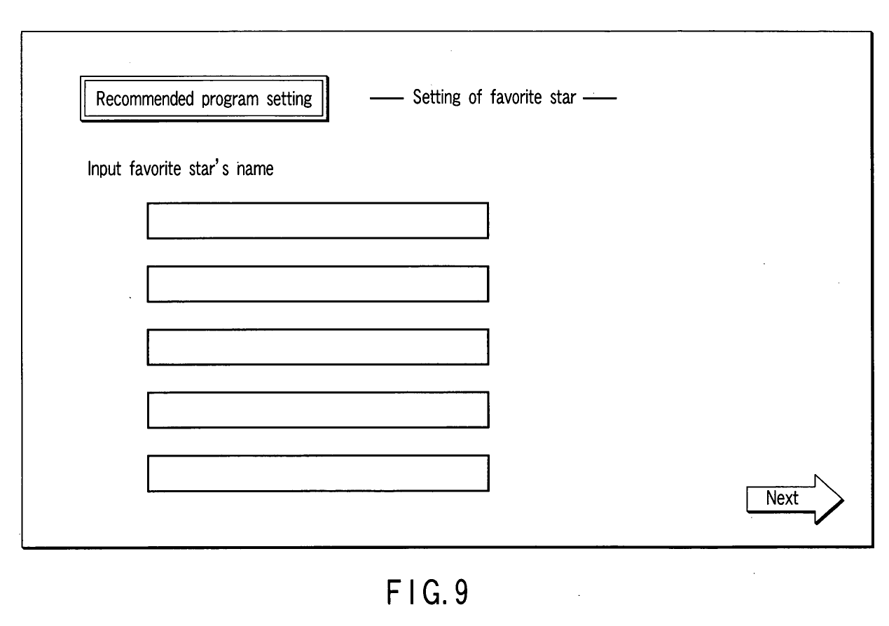

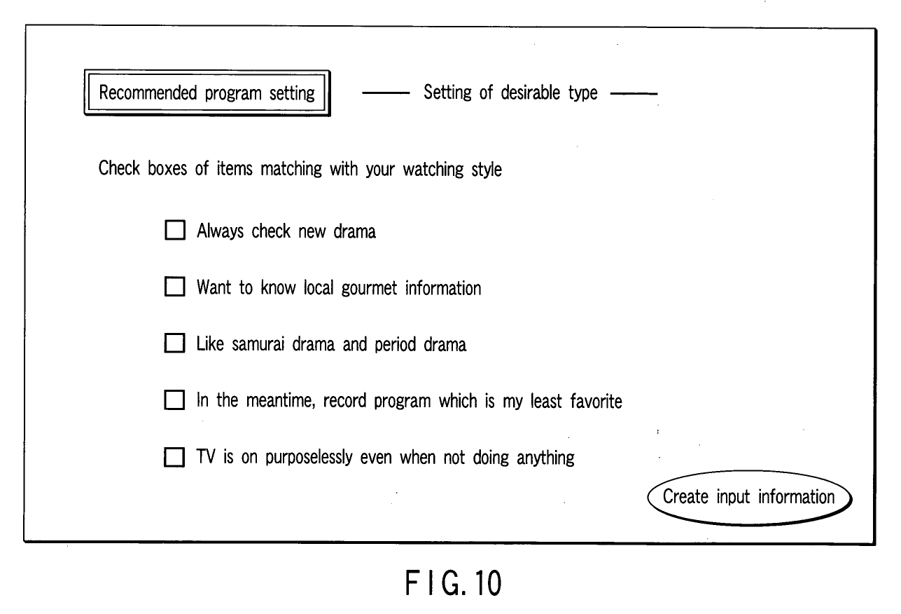

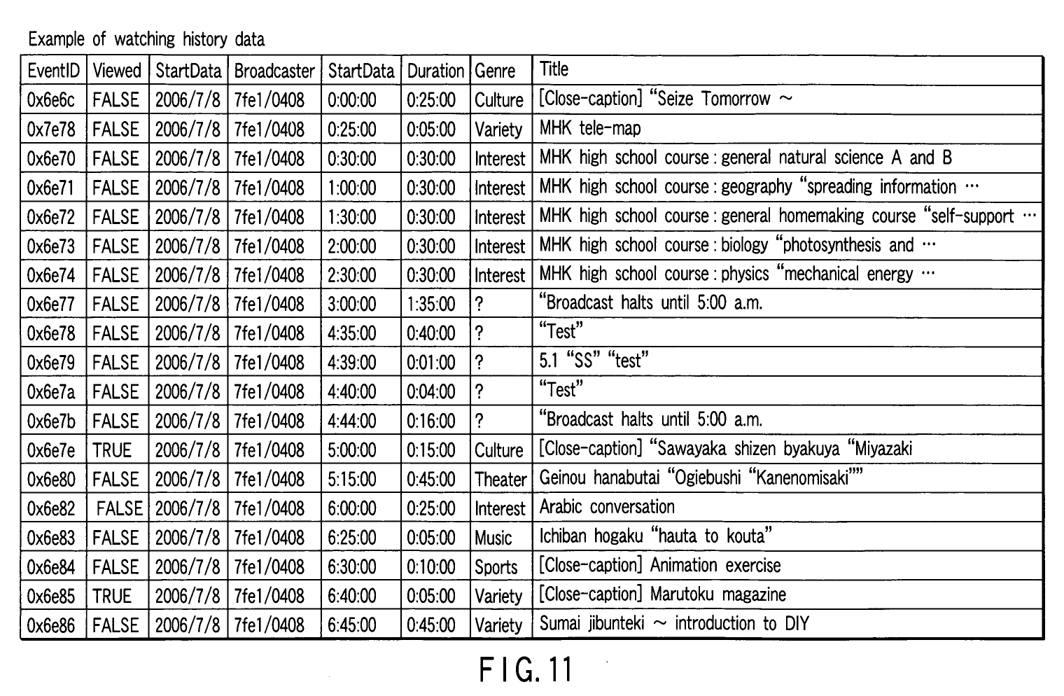

The broadcast receiver displays the user's recommended program setting screens in FIGS. 8 to 10 under the control of the controller 30 and the preference learning section 34 according to an user's operation of the operating section 32 (step S12). That is to say, when a favorite genre (desirable genre) setting screen shown in FIG. 8 is displayed (step S13) and “next” is specified after the user inputs suitable information, a favorite personality's name (desirable personality's name) setting screen shown in FIG. 9 is displayed (step S14). Similarly, when “next” is specified after the user inputs suitable information, a desirable type selecting screen according to a user's watching style shown in FIG. 10 is displayed (step S15). When a button “create input information” is finally pressed down (step S16), the controller 30 and the preference learning section 34 transmit various information input by the user, namely, the input information such as the user's favorite genre and favorite personality and desirable type to the server device S (step S17).

The “personality's name” means real names, screen names and group names of entertainers and celebrities who appear on TV shows.

The desirable genre means simply favorite program genre or wide-meaning genre, and include likes and dislikes in a broad sense. On the contrary, this desirably includes information about which genre is dislikable.

The desirable personality's name means simply favorite personalities and includes likes and dislikes in a broad sense. On the contrary, this desirably includes information about which personality is dislikable.

A plurality of users such as father, mother, brother and sister are set and the user's input information is created as inherent information for each of the set users.

The user's input information includes user's age, generation, sex and favorite genre and user's favorite personality's name, for example, but the information is not limited to them.

(Watching History Data Creating Process)

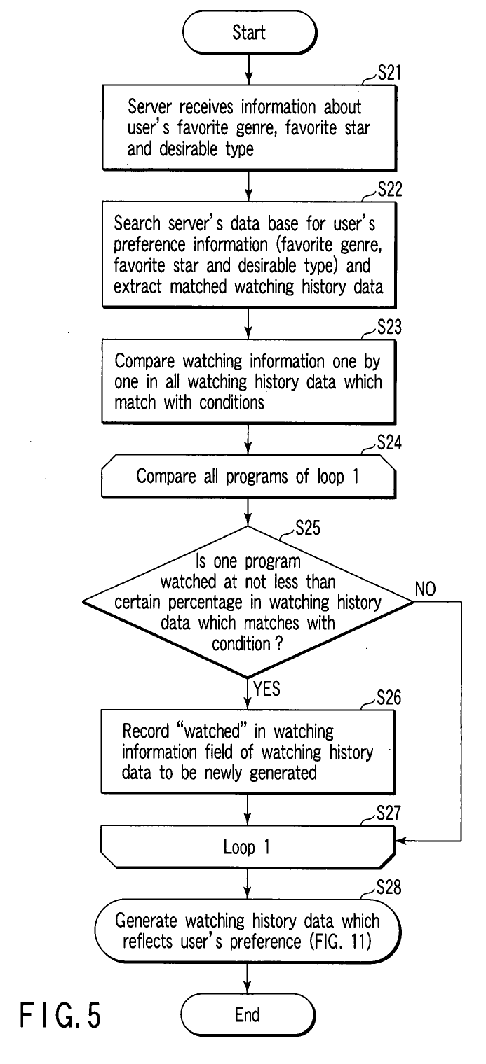

An optimum watching history data creating process which is executed based on the input information received from the broadcast receiver 10 in the server device S will be described below with reference to the drawings. FIG. 5 is a flowchart illustrating one example of the watching history data creating process in the server device for the preference learning function.

The server device S, as shown in FIG. 5, receives input information about at least user's favorite genre and favorite personality and desirable type from the broadcast receiver 10 via the I/F section 53 (step S21). The watching history data processor 52 searches the database section 51 of the server device S for preference information in the input information (favorite genre, favorite personality and desirable type) so as to extract matched watching history data (step S22).

The watching history data processor 52 compares watching history data for each program with all the extracted watching history data matching with the input information (step S23).

Hereinafter, a loop is set to all the watching history data and a comparison is made for each program (step S24). The watching history data processor 52 checks the watching history data matching with the condition for whether one program is watched at not less than certain percentage (step S25). When such a program is present, new watching history data is created, and “watched” is recorded in a watching information field of the watching history data (step S26). Such a loop 1 is repeated between steps S24 to S26 (step S27).

Such a process is executed on all the watching history data matching with the condition, so that watching history data which reflects the user's preference is created as shown in FIG. 11 (step S28). There are various methods for allowing the watching history data to reflect the user's preference, but as an example, it is desirable to create lists of program names watched repeatedly at not less than certain number of times and personalities' names watched repeatedly at not less than certain number of times.

In the server device S, the watching history data processor 52 creates the watching history data according to the input information from the broadcast receiver 10, and returns the watching history data to the broadcast receiver 10 via the I/F section 53. As a result, the broadcast receiver 10 can acquire optimum watching history data based on the database of a plurality of latest users' watching history data.

(Recommended Program List Creating Process)

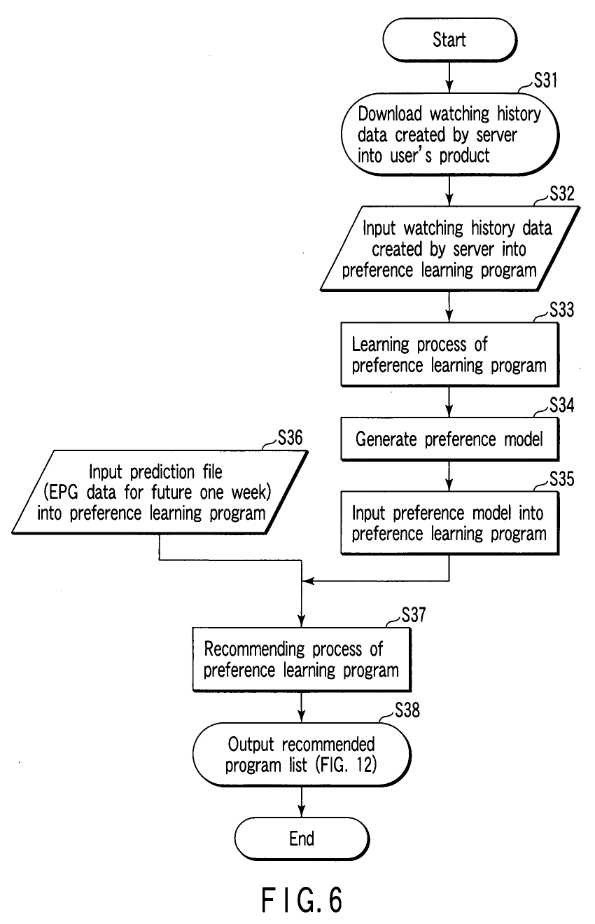

A process for creating recommended program list based on the watching history data acquired from the server device S in the broadcast receiver 10 will be described below with reference to the drawings. FIG. 6 is a flowchart illustrating one example of a recommended program list creating process using the watching history data in the broadcast receiver according to one embodiment of the present invention.

That is to say, in the broadcast receiver 10, the watching history data created by the server device S is downloaded into the preference learning section 34 via the communication section 11 (step S31). The preference learning section 34 inputs the watching history data created by the server device S into a preference learning program (step S32).

In the preference learning program of the preference learning section 34, the watching history data is subject to a statistical process (step S33), and preference model data which is convenient for creating the recommended program list is created (step S34). The preference model data is created in such a manner that elements including program names, program genre, personalities' names and program tendency are subject to the statistical process. The preference learning section 34 inputs the preference model data into the preference learning program (step S35).

It is not always necessary to convert the watching history data into the preference model data, and the watching history data may be compared directly with subsequent EPG data.

A prediction file (EPG data for future one week) is input into the preference learning program (step S36). The preference learning program of the preference learning section 34 is operated, and the preference model data (or the watching history data) is compared with the EPG data. The recommending process is executed (step S37), and the recommended program list shown in FIG. 12 is created so as to be output (step S38). The recommended program list of FIG. 12 is a list of programs according to the user's preference being present in the electronic program information, and contains program titles, guest names, potential frequency, and the like.

(Program Recommendation Display Process)

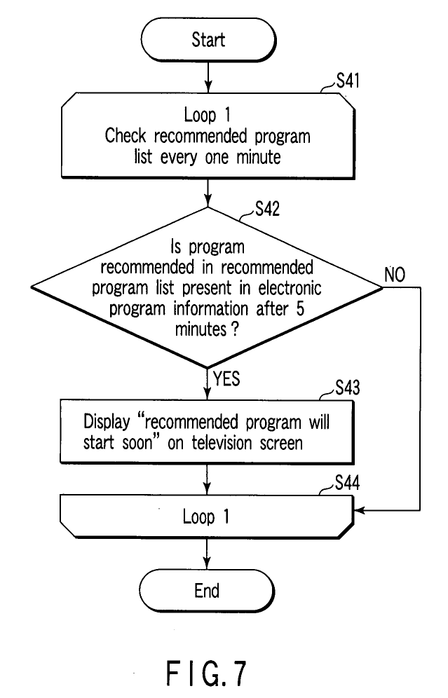

A program recommendation display process executed in the broadcast receiver 10 using the recommended program list will be described below with reference to the drawings. FIG. 7 is a flowchart illustrating one example of the program recommendation display process using the recommended program list in the broadcast receiver according to one embodiment of the present invention.

In the preference learning section 34 of the broadcast receiver 10, the created recommended program list (FIG. 12) is checked every one minute, for example (step S41). That is to say, the preference learning section 34 checks whether the programs of the recommended program list are present in the electronic program information after 5 minutes (step S42). When the programs of the recommended program list are present, image information of a program recommendation screen 112 such as “the recommended program will start soon” shown in FIG. 13 is created so as to be displayed on a television screen 111 (step S43).

When the programs are not present, the sequence goes to end of the loop process at step S44 so that the operation is repeated from step S41 (step S44).

As a result, the user can know that the program which matches with the user's preference will start on the television screen just after purchasing the television.

The method of using the recommended program list is not limited to this. When the broadcast receiver 10 as the hard disc recorder is cooperated with the timer recording section 42, even if a user's command is not given, the timer recording section 42 desirably executes timer recording on the program of the recommended program list included in the electronic program information automatically according to the user's setting of the automatic recommendation reservation.

Similarly in the broadcast receiver 10 as the hard disc recorder, the preference learning section 34, the timer recording section 42 and the program list creating section 43 are cooperated with one another, so that a screen for suggesting reservation of a program matching with the user's preference is created. This is desirably notified to the user. As a result, the user can easily reserve a program which matches with the user's preference.

(Transmission of User's Watching History Data)

In the broadcast receiver 10, it is necessary to transmit the watching history data of the users' broadcast receivers 10 to the server device S periodically in order to use the preference learning function. Accordingly, the preference learning section 34 of the broadcast receiver 10 saves the watching history data for each of a plurality of users registered in the controller 30, and periodically transmits the watching history data to the server device S via the communication section 11. As a result, a lot of users' watching history data are accumulated in the database section 51 of the server device S, thereby ensuring effectiveness of the preference learning function according to one embodiment of the present invention.

A person skilled in art can realize the present invention based on the above various embodiments, but the person skilled in the art easily conceives various modified examples of these embodiments. Even if the person skilled in the art has no inventive ability, the present invention can be applied to various embodiments. Therefore, the present invention covers a wide range which does not conflict with the disclosed principle and new feature and thus is not limited to the above embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A broadcast receiver comprising:
a tuner which receives and demodulates a broadcast signal;
an extracting section which extracts electronic program information from the demodulated broadcast signal;
a generating section which displays a setting screen and generates input information for the setting screen;
a communication section which transmits the input information to an external server device and receives watching history data corresponding to the input information from the server device; and
a preference learning section which creates a recommended program list based on the watching history data and the electronic program information and generates program recommendation screen information for displaying recommended programs according to the recommended program list.

2. The broadcast receiver according to claim 1, wherein the generating section generates a plurality of input information inherent in a plurality of users, respectively.

3. The broadcast receiver according to claim 1, wherein the watching history data which is generated by saving history data of respective users every time of watching programs is supplied to the server device via the communication section.

4. The broadcast receiver according to claim 1, wherein the input information includes at least one of user's age, generation, sex, favorite genre and favorite personality's name.

5. A server device comprising:
a communication section which communicates with an external broadcast receiver;
a database section which stores a plurality of watching history data therein; and
a processor which receives preference input formation from the broadcast receiver via the communication section, selects watching history data common to the input information from said plurality of watching history data in the database section and transmits the selected watching history data to the broadcast receiver via the communication section.

6. The server device according to claim 5, wherein the processor selects the watching history data with relation to the user's favorite program genre and personality's name based on the input information.

7. A program recommending method for a broadcast receiver, comprising:
extracting electronic program information from a broadcast signal;
displaying a setting screen and generating input information for the setting screen;
transmitting the input information to an external server device and receiving watching history data corresponding to the input information from the server device;
making a recommended program list based on the watching history data and the electronic program information; and
displaying a program recommendation screen for displaying recommended programs according to the recommended program list.

8. The program recommending method according to claim 7, wherein the input information is a plurality of input information according to a plurality of users.

9. The program recommending method according to claim 7, wherein the watching history data which is generated by saving history data of respective users every time of watching programs is supplied to the server device.

10. The program recommending method according to claim 7, wherein the input information includes at least one of user's age, generation, sex, favorite genre and favorite personality's name.
